(19) United States
(12) Patent Application Publication
(10) Pub. No.: US 2005/0203943 A1
(43) Pub. Date: Sep. 15, 2005

(54) Personalized classification for browsing documents

(75) Inventors: Zhong Su, Beijing (CN); Yue Pan, Beijing (CN)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/077,336

(22) Filed: Mar. 10, 2005

(30) Foreign Application Priority Data
Mar. 11, 2004 (CN) 200410028394.8

(51) Int. Cl. G06F 17/30

(52) U.S. Cl. 707/102

(57) ABSTRACT

The present invention provides document classification methods, apparatus and systems for browsing documents in the Internet. The method includes the steps of: creating a plurality of categories on the server side, assigning the documents to be browsed by the user to the corresponding categories, and managing said plurality of categories in a flat structure; and on the client side, selecting the required categories from the plurality of categories to create a personalized classification structure. The cost of calculating and storing can be greatly reduced by utilizing the system and method according to the present invention.

### FIELD OF THE INVENTION

The present invention relates to a personalized information service in a client-server structural network, and particularly to a personalized classification processing method and system for browsing documents in the Internet system.

### BACKGROUND

With the development of computing technology, people need a personalized information classification service. A personalized classification service provides means through which users can define their own category trees being different from that of the others. In this way user required documents will be mapped to the user-defined tree and a respective document directory will be generated. Such a personalized classification service is very important, because people have different interests and background.

In the prior art, it is required to build respective classification models for each user according to the users' different interests. Usually, since the document database is very huge, all documents have to be offline mapped to this classification model for the user and a document directory is generated (which can not be generated in real time), and the classification model for each user needs to be trained and studied based on the user's input and history log so as to improve the model, thus it is very difficult to provide a unified classification scheme for all users.

In, “Document Ontology Based Personalized Filtering System”, by Kyung-Sam Choi et al, a technical solution for building respective classification models for each user according to their different interests is disclosed. In other words, different people have different models.

For the provider, the biggest problem to provide such a service is the heavy computation and storage cost, and the leading reason of such a problem is that for each user, their classification models need to be trained and updated. As compared with the user's interests, his classification model is much huger in size and will cost huge storage costs even if it is supported by the system. If the updating occurs in the document database, it will result in updating of every user's document directory by applying classification algorithm on his/her classification model. The updating operation for such category tree is very complicated and expensive.

Thus, a flexible, simple, low-cost personalized document classification method and system is needed.

### SUMMARY OF THE INVENTION

To solve the above problems, the present invention provides a general classification model of a personalized service. In such a structure, no matter what difference exists among the users' personalized design, only a single system classification model needs to be trained and updated, and the users' personalized classification are generated on the basis of this system classification model. Only little cost is required, because only one system classification model needs to be trained, rather than needing different classification models trained for every user.

One aspect of the present invention provides a document classification method, including the steps of: creating a plurality of categories on the server side, assigning the documents to be browsed by the user to the corresponding categories, and managing said plurality of categories in a flat structure; and on the client side, selecting the required categories from the plurality of categories to create a personalized classification structure.

Another aspect of the present invention provides a document classification system, including a server and a client connected via a network, characterized in that it further comprises: system classifying means configured on said server side for creating a plurality of categories for the respective documents to be browsed by the user, assigning said respective documents to the corresponding categories, and managing said plurality of categories in a flat structure; and customizing means configured on said client side for selecting the required categories from said plurality of categories, so as to create a personalized classification structure.

### BRIEF DESCRIPTION OF THE DRAWINGS

For a more complete understanding of the present invention and the advantages thereof, reference is now made to the following description taken in conjunction with the accompanying drawings, in which:

FIG. 1 is a schematic view showing an example of a general system according to the present invention;

FIG. 2 is a view showing an example of a more detailed structure of the system according to the present invention;

FIG. 3 is a schematic view of an example of a classification structure managed in a flat structure in the server according to the present invention;

FIG. 4 is a schematic view of a classification tree structure defined in the client according to the present invention;

FIG. 5 is a schematic view of another classification tree structure defined in the client according to the present invention;

FIG. 6 is a schematic view of an example of a classification matrix according to the present invention.

FIG. 7 is a schematic view explaining an example of a manner in defining the classification tree structure; and

FIG. 8 is a flow chart illustrating an example of a document classification method implementing the present invention.

### DETAILED DESCRIPTION OF THE INVENTION

The present invention provides a general classification model of a personalized service. The structure is such that no matter what differences exist among the users' personalized design, only a single system classification model needs to be trained and updated, and the users' personalized classification are generated on the basis of this system classification model. Only low cost is required, because only one system classification model needs to be trained, rather than different classification models are respectively trained for every user.

In one embodiment, the present invention provides a document classification method. An example of a method includes the steps of: creating a plurality of categories on the server side, assigning the documents to be browsed by the user to the corresponding categories, and managing the plurality of categories in a flat structure; and on the client side, selecting the required categories from the plurality of categories to create a personalized classification structure.

In another embodiment, the present invention further provides a document classification system. An example of a classification system includes a server and a client connected via a network, system classifying means configured on a side of the server for creating a plurality of categories for the respective documents to be browsed by the user, assigning the respective documents to the corresponding categories, and managing the plurality of categories in a flat structure; and customizing means configured on the client side for selecting the required categories from the plurality of categories, so as to create a personalized classification structure.

In the present invention, the personalized classification structure is a tree structure, and each node of the tree structure includes one or more categories. The advantages of such a structure is that: while the user changes his/her category design, no change is required on the server side, and while the server side is updated, only the system classification model needs to be updated, and it is not necessary for the user himself/herself to be an expert in the respect of document classification. Thus, the system and method according to the present invention can save a great deal of cost of calculating and storing.

In advance of describing the embodiments in details, a group of concepts pertinent to the present invention will be defined at first.
Category: Representing a logical group of associated documents, each category (also referred to as category model) is often represented by a group of keywords to reflect the category meaning of the documents contained therein, such as news, finance and economics, sports, entertainment, new technology and the like.
Personalized classification: Representing that a user is allowed to define their own categories and category structures and the documents are automatically assigned to these structures.
Binary classifier: Having a function of transforming an input document into binary labels (e.g. {0, 1}).

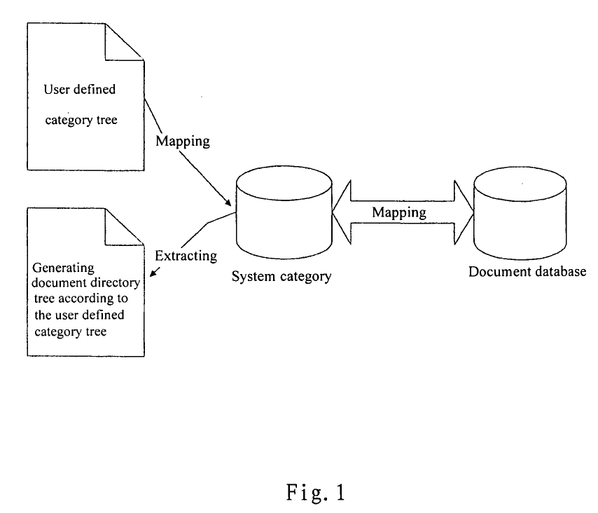

Hereinafter, the specific embodiments according to the present invention will be described in details in conjunction with the attached drawings. FIG. 1 is a schematic view showing the general system principle according to the present invention. As shown in FIG. 1, in the server, a plurality of system categories are generated for various documents at first, and stored in “system category library”, and the corresponding documents stored in the “system category library” are automatically classified into these system categories which are managed in a flat structure in the “system category library”; in the client, a user defines a desired classification tree structure, and the tree structure is mapped to the “system category library” in the server; the “system category library” extracts the required documents for the user from a “document database” by the user selecting a specific node in the classification tree structure, and provides them to the client of the user to be displayed.

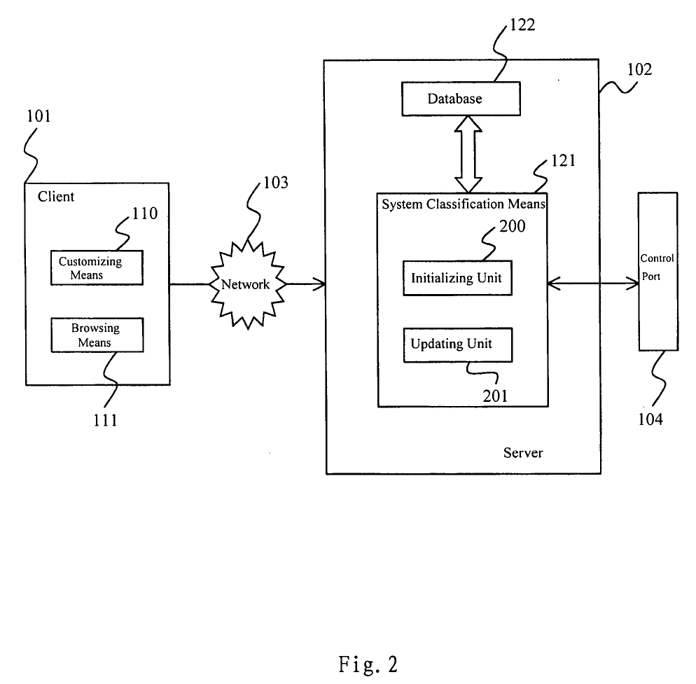

FIG. 2 is a view showing the more detailed structure of the system according to the present invention. As shown in FIG. 2, the system according to the present invention mainly includes two parts, i.e. a client 101 and a server 102, which are connected through various networks 103 such as local area network (LAN), wide area network (including Internet), which form a system with a client-server structure. The typical structure suitable for it is Internet.

The server 102 includes: a database 122 in which a great number of various documents that the service provider can collect and their associated information are stored to be browsed by the user through the network; and a system classification means 121 which builds a plurality of categories (models) for the documents to be browsed, i.e. so-called system classification model, and assigns the documents to corresponding categories aligned in flat structure in the server.

Moreover, the system according to the present invention further includes: an initializing unit 200 connected with the system classification means 121 or configured therein for performing initializing (modeling) operation on various basic information models; and a updating unit 201 connected with the system classification means 121 or configured therein for performing operations such as updating and the like on the documents and/or categories.

The system according to the present invention can further includes a control port 104 for controlling the operations with respect to document processing in the system classification means 121 by inputting control commands to the system classification means 121. Control port 104 can be an input device such as keyboard, mouse, tablet, microphone or photographing part.

Of course, the system classification means 121 according to the present invention can perform the above operations on its own under software control without depending on the administrator inputting related control commands via control port 104. In addition, the system classification means 121 according to the present invention can also be configured as not including or connecting with the initializing unit 200 and the updating unit 201, but performing the above various functions as an independent means or unit.

In the client 101, there is included a customizing unit 110 for selecting required categories from the plurality of categories provided by the server 102 to build a personalized classification structure, and a browsing unit 111 for receiving the documents that the user wants to browse from the system classification means 121 and rendering them to the user, in the case that a specific node of the classification tree structure is selected. The above mentioned customizing unit 110 and browsing unit 111 can be combined into a single unit to perform the same function. The user interacts with the server 102 via a graphic user interface (not shown) such as web page provided by the server 102, and maps the desired categories tree structure defined by themselves to the system classification means 121 in the server 102, and the system classification means 121 provides document information required by the users to the client 101 according to the categories tree structure defined by the user.

During the interaction between the client 101 and the server 102 through network, a token with the related description information attached thereon can be used as a signaling between the client 101 and server 102 to pass various massages. Certainly, any other kind of massage passing manner can also be used, since the massage passing manner within the network is not the object of the present invention, and it is a well-developed technology. The detailed description thereof is omitted herein.

In the present invention, the server 102 and client 101 certainly further include various general purpose means like CPUs, various memories and input/output devices to implement various basic operations. Also, the server 102 and client 101 according to the present invention can be a general purpose server and client, in which the present invention is implemented by uploading a software program capable of realizing various functions of the present invention.

In the present invention, the initializing unit 200 in the system classification means 121 builds a set of basic information models such as list, table and the like, including category set, bit string array, category table, category update list, document set, document update list and classification matrix et al, for the various documents stored in the database 122.

Next, the various basic information models and their initializing operations will be described in conjunction with the attached drawings.

In the above mentioned basic information models, category set is represented as C={c1, c2, . . . cm}, where ci (i=1, 2, . . . , m) represents respective categories, m is the total number of all categories in the category, and i represents the corresponding category identification information, i.e. category ID. Here, the category ID appears as the positional information of respective category in the category set. Certainly, the category ID can also be any other information which can be used to identify the category, including but not limited to positional information. For example, the documents with respect to network life in the database 122 can be classified into six categories, i.e., C_example={internet, software, programming, game, shopping, hardware}. Wherein, c1 is “internet”, c2 is “software”, and so on, and m=6, i.e. totally six categories. Certainly, the documents can be arbitrarily classified based on the kinds thereof, the above mentioned manner is just an example, and is not used to limit the present invention.

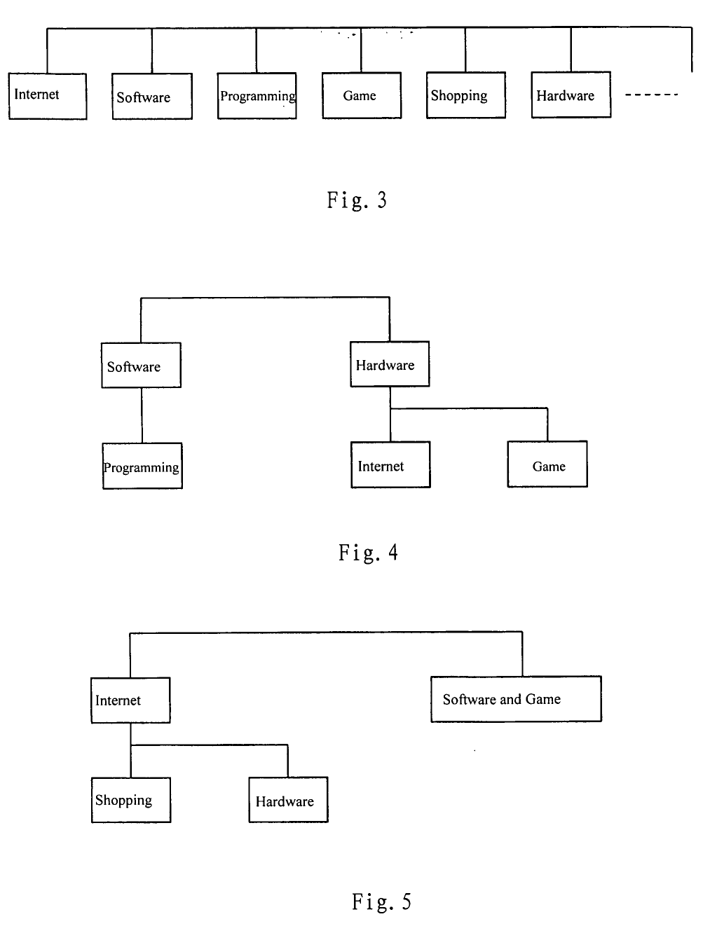

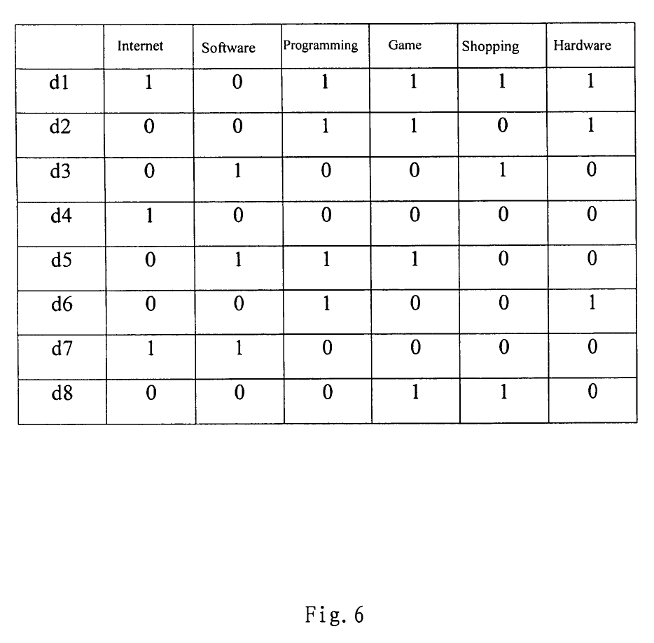

FIG. 3 is a schematic view of the classification structure managed in a flat structure in the server according to the present invention. FIG. 4 is a schematic view of a classification tree structure defined in the client according to the present invention. FIG. 5 is a schematic view of another classification tree structure defined in the client according to the present invention.

As shown in FIG. 3, there is no mutual subordinate relationship among respective categories in the server 102, and the categories are only managed in a flat structure. While in the client 101, the user can define his/her own personalized classification schema based on such category set in the server 102, for example, a tree structure with each node corresponding to one or several categories in the category set C. For example, for the category set C_example in the server 102, the user can define in the client 101 a tree structure as shown in FIG. 4, as well as the tree structure as shown in FIG. 5. In the tree structure as shown in FIG. 5, a node tr10 corresponds to two categories in category set C_example, i.e. “software” and “game”.

Thus, since only one flat category structure is managed, the complexity in managing data in the server 102 side is reduced, and users can customize classification browsing structure as they desire on the client 101 according to their own interests.

Each category ci has a binary classifier fi uniquely corresponding thereto, for binary-classifying all documents in the category ci. In the present invention, any kind of binary classifier could be applied, such as SVM binary classifier, Bayesian binary classifier, and so on, all of which are well-developed technologies in the art, and the detailed descriptions thereof will be omitted herein.

Each category ci has a bit string uniquely corresponding thereto, which represents the position of the category ci in the category set C, and every bit string composes a bit string array. Here, the bit string is represented as si={bij□j=1 . . . m, bij=0, if i<>j, and bij=1 if i=j}. It can be understood as follows, taking the above mentioned category set C as an example, wherein c4=“game”, then the bit string corresponds to it is s4={0, 0, 0, 1, 0, 0}. In other words, when j=i=4, s4=b_{4,4}=1, and other bits in the bit string are zeros, it means that the category “game” is at the fourth position in the category C_example. In the above mentioned bit string array, each bit string corresponding to respective categorys in the category set C is included.

The document set is represented as D={d1, d2, . . . , dn}, dj(y=1, 2, . . . , n) represents each document in the document set D, wherein, j represents the identification information for each document, i.e. document ID. Here, document ID appears as the positional information of respective document in the document set D. Certainly, the document ID can also be any other information which can be used to identify the document, including but not limited to its positional information. The document set D includes all documents stored in the database 122 of the server 102 and allowed to be browsed by the user, and these documents are assigned into corresponding categories according to the different kinds. All documents dj are processed by each binary classifier fi corresponding to respective categorys ci, so that each document becomes a binary value with respect to each category, thereby an output vector for each document is formed, which is represented as vj=(vj1, vj2, . . . , vjm). Here, if a document dj belongs to a particular category, then the binary value of the document under the particular category is 1; whereas if a document dj does not belong to a particular category, then the binary value of the document under the particular category is zero.

For example, there are eight documents in the above mentioned document D, i.e. D={d1, d2, . . . , d8}, wherein the third document d3 belongs to category c2=“software” and c5=“shopping”, thus the output vector of the document d3 is {0, 1, 0, 0, 1, 0}.

FIG. 6 is a schematic view of the classification matrix according to the present invention.

By means of the above defined category set C and document set D, all categories and documents can be formed into a matrix structure M with j rows and i columns, wherein every element m_{j,i}=v_{j,i} in this matrix structure represents the result of binary-classifying document dj under category ci, as shown in FIG. 6.

In addition, a category table being represented as CTi is provided in initializing unit 200. Each category table corresponds to a category ci, and stores the identification information for all documents contained in the category. In order to increase the access speed, a high efficient data structure, such as B-tree structure or Binary Balance tree structure can be used to implement the category table. Therefore, a category table is actually a set of lists. As in the example mentioned above, there are 6 categories and 8 documents with reference to FIG. 6, in which category table CT₁={1, 4, 7} corresponds to category c1=“internet”, and documents d1, d4 and d7 belong to that category; category table CT₂=(3, 5, 7) corresponds to category c2=“software”, and documents d3, d5 and d7 belong to that category; similarly, category table CT₆={1, 2, 6} corresponds to category c6=“hardware”, and documents d1, d2 and d6 belong to that category.

The various basic information models formed above can be stored in database 122, and also can be stored in other storage devices (not shown) in the server 102.

In addition, by means of the updating unit 201 in the system classification means 121, the documents and categories can be updated on the basis of the classification matrix formed above, i.e. adding new documents or categories, or deleting existing documents or categories.

Such an updating operation can be performed by the network (or the server) administrator inputting control commands via the control port 104, alternatively, it can also be independently performed by the updating unit 201 under the control of a software. Wherein, in the operation of adding documents and categories, updating unit 201 inputs the contents of the newly added document or category into the binary classifier (not shown), and output an output vector (the result of binary-classifying) corresponding to the document or the bit string corresponding to the category from the binary classifier, and add these output values into the classification matrix M.

For a newly inserted document, it will be represented as a newly inserted line in this classification matrix M, and for document deleted, it will be represented as a deleted line in the matrix. Also, for category set update, it will be represented as the corresponding column inserting (adding category) and column deleting (deleting category) in the matrix.

In order to facilitate the updating operation, the initialing unit 200 further creates a category update list Lc and a document update list Ld. In the category update list Lc, the positional information on the deleted category ci in category set C (i.e. a certain column in the matrix M) is recorded, while in the document update list Ld, the positional information on the deleted document dj in the document set (i.e. a certain row in the matrix M) is recorded. Both the document update list Ld and the category update list Lc can be implemented by using stack data structure. For example, in the above example, there are 6 categories, and now the category update list Lc is empty. Suppose we add in a category c7, the category ID of the newly added category will be 7 since the Lc is empty, therefore the seventh column c7 will be added into the matrix M. However the category update list Lc is not changed at this time.

Suppose we delete category c3 now, while performing corresponding deleting operations, an identification information 3 (which represents here the positional information) is added into category update list Lc, i.e. Lc={3}, wherein the identification information “3” represents that the third column of the matrix M is now empty. Thus, if we will add in a new category later, since there is a value (i.e. identification information) in Lc, the identification information “3” is extracted from Lc, and is assigned to the newly added category ID, so that the newly added category is c3, and it is not necessary to add a new category ID “8” for it. Thus, a great deal of storage space can be saved for the server 102, and the work efficiency of the whole system can be greatly improved.

Also, when a new category ci is added, the status of all documents under the category ci should be determined. If the result of binary-classifying a certain document dj under the category ci is 1, the identification information j of the document dj should be recorded into the category table CTi corresponding to the category ci.

The program codes for implementing the above operation of deleting a category are given as follows:

```
Delete an existing category ci
    push i inito Lc.
    delete CTi
for(k=1,k<=n,k++)
        mk,i=0;
    delete ci from C
```

The program codes for implementing the above operations of adding a category are given as follows:

```
Insert a new category c with associated classifier f;
    if(Lc is empty)
        Category id of c: i=sizeof(C)+1
    else
        i=pop(Lc)
    ci=c; fi=f;
    initial si and CTi;
    for(k=1,k<=n,k++)
    {
        mk,i=fi(dk);
        if(mk,i=1)
        {
            insert k into CTk.
        }
    }
    insert ci into C
```

The structure and operational principle of the document update list Ld is substantially the same as that of the category update list Lc. For some newly added documents dj, if the result of binary-classifying under a certain category ci is 1, the identification information j of the document is added into the category table CTi of the category. Thereby, the detailed description for it is omitted herein.

The program codes for implementing the above operation of deleting a document are given as follows:

```
Delete an existing document dj
    push j into Ld
    for(k=1,k<=m,k++)
    {
        if(mj,k=1)
        {
            delete j in CTk;
            set mj,k=0;
      }
    }
    delete dj from D
```

The program codes for implementing the above operation of adding a document are given as follows:

```
Insert a new document d
    if(Ld is empty)
        document id of d: j=sizeof(D)+1
    else
        j=pop(Ld)
    dj=d;
    insert dj to D;
    calculate vj;
    for(k=1,k<+m,k++)
    {
            mj,k=vj,k;
        if(vj,k=1)
        {
          insert k into CTk
        }
    }
```

Thus, a unified model in a flat classification structure is created in the server 102. The unified model has a simple structure, and while being utilized, only this model needs to be trained and updated, and it is not necessary to train and update more classification models.

Next, a method in which the user defines a personalized classification structure will be described in conjunction with the drawings.

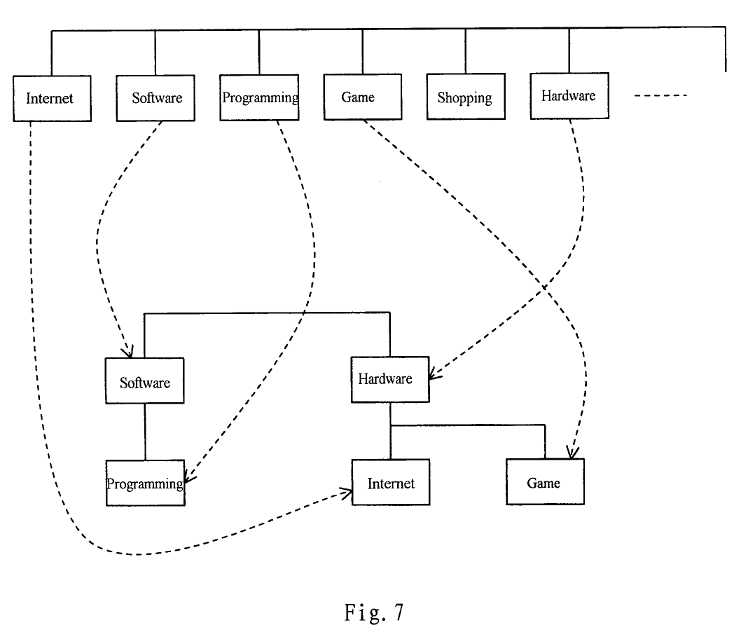

FIG. 7 is an example illustrating that the user defines a classification tree structure on the client 101. Here, the tree structure is used as an example of the personalized classification structure. Certainly, the user can use other structures to implement the personalized classification structure. As described above, the user can select one or more categories from the flat category structure in the client 102 for every node in the tree structure T defined by the user. Then, a corresponding category set Cx is generated for a node tx in the category tree structure T. the category set Cx belongs to the category set C, and includes one or more categories in the category set C. For example, referring to FIG. 5, the nodes tr20, tr10, tr12 and tr13 are respectively “software and game”, “internet”, “shopping” and “hardware”, wherein the root node tr10 corresponds to the categories “software” and “game” in the category set C_example, based on which a new category set Cx is formed, which consists of the categories “software” and “game”.

The operational method of forming a classification tree structure on the client 101 is of common sense for those skilled in the art, for example, it can be performed by dragging a category icon displayed on the web page provided by the server 102 with a mouse to a specific position as prompted in the web page, also, it can be performed by entering character information into a prompt box. The detailed descriptions for it will be omitted herein.

When the user creates the root node tr, if the user only selects one category ci, the category ci is assigned to the root node tr, and the root node tr can be represented by the bit string si of the category ci. For example, if the node c2=“software” is assigned to the root node tr, since the bit string corresponding to the category c2=“software” is si={0, 1, 0, 0, 0, 0}, the root node tr=s2={[0, 1, 0, 0, 0, 0]}. Certainly, two or more root nodes can be selected, as the structure shown in FIG. 4, then there are root node tr1=s2={[0, 1, 0, 0, 0, 0]} and root node tr2=s6={[0, 0, 0, 0, 0, 1]}.

If the user selects two or more categories at root node tr, for example ci and ci+2, the logical relationship between the two or more categories should be determined.

If the relationship between the categories ci and ci+2 is logical “OR”, i.e., the root node should have all documents in both ci and ci+2. In this case, an logical “OR” operation is performed on all documents in ci and all documents in ci+2, and the result serves as the category in the root node tr, and then the root node tr is represented by {[si]∪[si+2]}. For example, in the example mentioned above, as shown in FIG. 5, categories c2=“software” and c4=“game” are selected at root node tr20, which requires that all documents in both category c2=“software” and category c4=“game” should be contained in the root node. Since the bit string corresponding to category c2=“software” is s2={0, 1, 0, 0, 0, 0}, and the bit string corresponding to category c4=“game” is s4={0, 0, 0, 1, 0, 0}, the root node tr20 is represented as tr20={[si]∪[si+2]}={[0, 1, 0, 0, 0, 0]∪[0, 0, 0, 1, 0, 0]}, which means that after the above logical “OR” operation, all documents in the category c2=“software” and those documents in category c4=“game” which are not duplicated with documents in category c2=“software” are included in the root node tr20.

Next, the method of defining each sub-nodes below the root node on the client 101 will be described.

When defining respective sub-nodes, in addition to the same processes as performed in defining the root node above, an logical “AND” operation is performed on the categories contained in the sub-node to be defined and the categories contained in its parent node (i.e. superior node), and the result serves as the categories finally contained in the defined sub-node. For example, as shown in FIG. 5, in defining the categories contained in node t12, category c5=“shopping” is assigned to node t12 at first, i.e. t12=s5={[0, 0, 0, 0, 1, 0]}. Then, since its parent node tr20 contains category c1=“internet”, i.e. tr20=s1={1, 0, 0, 0, 0, 0}, an logical “AND” operation is performed on category c5=“shopping” and category c1=“internet”, and the result of the operation serves as the categories contained in node t12, i.e. tr12={[s5]∩[s1]}={[0, 0, 0, 0, 1, 0]∩[1, 0, 0, 0, 0, 0]}, which means that after the above logical “AND” operation, node t12 contains the documents which belong to both category c5=“shopping” and category c1=“internet”.

Thus, a user can define a document classification structure he/she desired on the client 101. For example, the user defines a classification structure as shown in FIG. 4.

Such a classification structure defined by the user needs only to be mapped onto the server 102, so that the server 102 can extract the documents required by the user from the database 122, and provide them to the client 101, while it is not necessary to train the classification structure as a fixed classification model, because the user can modify it according to his/her thoughts at any moment. Thus, the work load for computing and storing in the server 102 is greatly alleviated.

A section of program code capable of implementing the above function is given as follows, and a user-defined classification tree structure can be generated according to the method below.

```
Algorithm calculating the node bit string of node ti
    Bitstring node_bit_string(ti)
    {
      if ti=root(T)
      {
        bit_ret=0;
        traversal all element c in Ci
        {
            bit_ret [symbol] =bit string of c; //where [symbol] is bit operation ‘or’
        }
      }
      else
      {
        bit_ret=0;
        traversal all element c in Ci
        {
          bit_ret [symbol] =bit string of c;//where [symbol] is bit operation ‘or’
          }
          bit_ret [symbol] =node_bit_string(parent node of ti);//where [symbol] is
bit operation ‘and’
        }
      return bit_ret;
    }
```

In addition, when the root node tr is defined, in some cases, the relationship between the categories ci and ci+2 can be the logical “AND” (not shown), i.e. only the documents which simultaneously exist in category ci and category ci+2 are contained in the root node tr20. In this case, as being the same as the method of defining sub-nodes, an logical “AND” operation is performed on all documents in ci and all documents in ci+2, and the result serves as the categories contained in the root node tr, then the root node tr is represented as {[si]∩[si+2]}. For example, in the example mentioned above, if the categories c2=“software” and c4=“game” are selected at the root node tr20 in FIG. 4, all documents which simultaneously exist in category c2=“software” and category c4=“game” are required to be contained in the root node. Then, since the bit string corresponding to category c2=“software” is s2={0, 1, 0, 0, 0, 0}, and the bit string corresponding to category c4=“game” is s4={0, 0, 0, 1, 0, 0}, the root node tr20 is represented as tr20={[s2]∩[s4]}={[0, 1, 0, 0, 0, 0]∩[0, 0, 0, 1, 0, 0]}, which means that after the above logical “AND” operation, the root node tr20 contains the documents simultaneously belonging to both the category c2=“software” and the category c4=“game”.

A simple example of the method of defining a root node and its respective sub-nodes are described above. In actually defining respective nodes, there are always a plurality of categories, and the relationships among the categories are complex intercross of logical “OR” and logical “AND”. In this case, a corresponding logical operation can be performed according to the principle of the above method, only the result of the operation will be more complex.

The user, of course, can also simultaneously define a plurality of classification tree structure on one client 101, that is to say, determining a plurality of root nodes, and the method is the same as the above mentioned method.

Next, the process for the user to browse corresponding documents by selecting a node on the client 101.

When a specific node tx is selected on the client 101, a condition information such as maximal number, date and the like of the documents that the user desires can be simultaneously provided. If the condition information is not provided, the default value for the respective condition information can be provided.

At this time, the respective categories contained in the node and the logical relationships thereof are determined by means of the bit string of the specific node tx. For example, in the example shown in FIG. 4, if the node t12 is selected, by means of the bit string t12={[0, 0, 0, 0, 1, 0]∩[1, 0, 0, 0,0, 0]}, it can be determined that the node t12 contains the category c5=“shopping” and category c1=“internet”, and the logical relationship between the two categories is the logical “AND”.

Then, the system classification means 121 traverses (searches) each of category tables respectively corresponding to each category, so as to determine which category contains fewer documents, and arranges the above categories in the order from the fewer to the more starting from the category determined as containing the fewest documents. For example, after performing traversal on the category tables CT5 and CT1 corresponding to the categories c5 and c1, it is found that category c5 contains 30 documents and category c1 contains 500 documents, thus, the system classification means 121 determines that the category c5=“shopping” contains the fewest documents, and arranges the two categories in the order of c5, c1.

Next, system classification means 121 searches the category containing the fewest documents for the documents meeting the conditions of the specific node tx, and provides the resultant documents to the client 101 in the following processing, so as to be browsed by the user. In other words, the system classification means 121 searches the database 122 for the documents contained in category c5=“shopping” and meeting the condition of t12={[0, 0, 0, 0, 1, 0]∩[1, 0, 0, 0,0, 0]}, and provides the resultant documents to the client 101 in the following processing.

If all documents meeting the condition, which are searched from the category containing the fewest documents, has not reached the number condition required by the user, the system classification means 121 continues searching in the category containing the second fewest documents as determined. In this example, it continues searching the documents meeting the above condition in category c1=“internet” until the number required by the user is reached.

During the above searching, system classification means 121 provides a list of the resultant documents to the client 101 in real time, and forms a document list provided in real time, and the list is displayed on the display device (not shown) of the client 101.

If the user wants to read a certain document listed in the above document list, he/she performs a selecting operation by means of an input device (not shown, such as keyboard, mouse, tablet and so on). Then, the browsing unit 111 notifies the server 102 of the selected result, and the server extracts the selected document from the database and provides it to the browsing unit on the client 101 to be displayed on the display device.

In the cases of the classification tree structure as defined in FIG. 4, referring to the classification matrix as shown in FIG. 6, the user can obtain three documents d3, d5 and d7 at the node tr1, i.e. the item “software”, and can obtain three documents d1, d2 and d6 at the node tr2, i.e. the item “hardware”. The user can obtain one document d5 at the node t1, i.e. the item “programming”, thus the document d5 also belongs to its superior node tr1. The user can obtain one document d1 at the node t2, i.e. the item “internet”, and can obtain two documents d1 and d2 at node t3, i.e. the item “game”, thus the documents d1 and d2 also belong to its superior node tr2. During the above process, the server 102 provides to the client 101 a document list for each category item in real time. In the following processing, the documents required by the user are provided to the client 101 according to the selected result on the client 101.

If there are a plurality of categories in a specific node tx, it performs searching in a manner similar to the above. A section of program codes for implementing the above function is given as follow:

```
algorithm Anode (ti, T, max_return_number)
        initial return document set ret_set=empty set
        calculate node bit string si of node ti
              arg min
        find cj where sizeof(ck) (kth bit of si =1)
        1=0;
        traversal all document d in CTj
        {
            if ((vd [symbol] si)==si)//where [symbol] is bit operation ‘and’
            {
                insert d into ret_set;
                1++;
                if (1>=max_return_number)
                    return ret_set;
            }
        }
      return ret_set;
```

In the above program, the variable ti represents the node specified by the user, T represents the classification tree to which the node ti belongs, max_return_number represents the maximal number of documents that the user desires to be returned, and ret_set represents the documents actually returned.

During the above searching process, the amount of calculation and searching in the server 102 can be reduced by starting searching for the documents to be browsed from the category having the fewest documents, thus the computing load borne by the server 102 can be efficiently reduced.

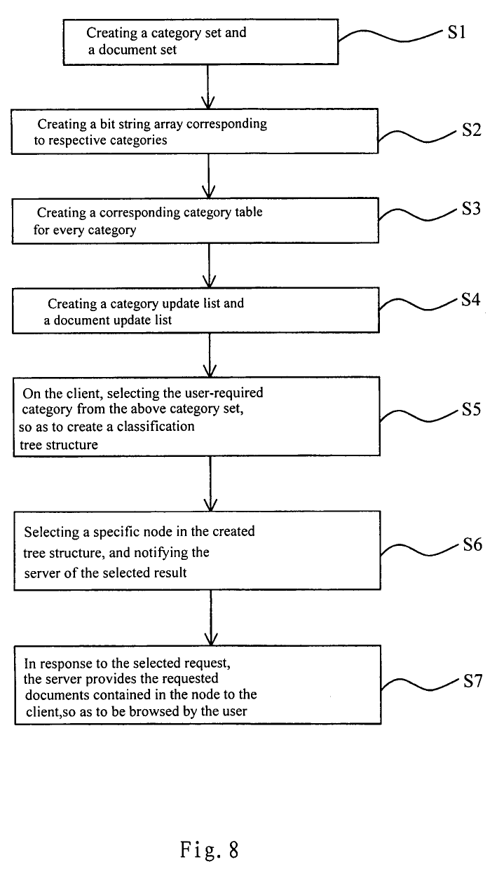

Next, the flow for implementing the document classification method according to the present invention will be described in conjunction with FIG. 8.

FIG. 8 is a flow chart illustrating the document classification method implementing the present invention. As shown in FIG. 8, a plurality of categories are created for the documents to be browsed on the server 102 at first, and the documents are assigned to the corresponding categories, wherein the plurality of categories are managed in a flat structure (as shown in FIG. 3).

At step S1, a category set C and a document set D are created respectively, wherein the category set C includes a plurality of the categories ci, each of the categories has an unique identification, the document set D includes all documents dj to be browsed, each of the documents has its unique identification information.

At step S2, a bit string array S containing a plurality of bit strings is created, wherein each bit string si represents the position of the corresponding category ci in the category set C.

At step S3, a corresponding category table CTi is created for each category, in which the unique identification information of the respective documents belonging to the category is stored. The respective documents dj is binary-classified, so that if a document belongs to a certain category, the result of binary-classifying the document under the category is 1, and the identification information of the document is inserted into the category table of the category, if a document does not belong to a certain category, the result of binary-classifying the document under the category is 0.

At step S4, a category update list Lc and a document update list Ld are created to record the update status of the category ci and the document dj respectively. Wherein, the identification information of the category ci includes the positional information of the category ci in the category set C, and the identification information of the document dj includes the positional information of the document dj in the document set D. During updating, the following sub-steps can be included:

When a category ci is deleted, its corresponding bit string si is deleted, and the positional information of the category ci in the category update list Lc is marked in the category update list Lc, which represents that the position is empty.

When a category ci is inserted, the category update list Lc is searched firstly, and if a marked positional information is found, the category ci is inserted into the corresponding position in the category set C, and the positional information in the category update list Lc is deleted; if no marked positional information is found, the category ci is inserted into a new position in the category set C. And a bit string si corresponding to the inserted category ci is added into the bit string array S.

When a document dj is deleted, the identification information of the document dj is deleted from respective category tables CTi, and the positional information of the document dj in the document set D is marked in the document update list Ld, which represents that the position is empty.

When a document dj is inserted, the document update list Ld is searched firstly, and if a marked document positional information is found, the document dj is inserted into the corresponding position in the document set D, and the positional information in the document update list Ld is deleted.

If no marked document positional information is found, the document dj is inserted into a new position in the document set D, and at the same time, the document identification information is inserted into the respective category tables.

Next, at step S5, on the client 101, the categories that the user requires are selected from the above category set C to create a personalized classification structure, and the personalized classification structure is mapped onto the server 102. The above mentioned personalized classification structure can be a tree structure, and each node of the tree structure includes one or more categories. In particular, when a root node tr is created, a logical “OR” operation or a logical “AND” operation is performed on the selected one or more categories, and the result serves as the categories contained in the root node tr; and when a sub-node is created, a logical “OR” operation or logical “AND” operation is performed on the one or more categories selected for the sub-node tx, then a logical “AND” operation is further performed on the result and the categories in the parent node of the sub-node tx, and the result of the logical “AND” operation serves as the categories contained in the sub-node tx.

At step S6, the user selects a specific node in the tree structure on the client 101, and determines the respective categories contained in the node. The selected result is notified to the server 102.

At step S7, in response to the selected request, the server 102 determines the number of the documents recorded in the category tables corresponding to the respective categories, and starts to search for the document to be browsed starting from the category containing the fewest documents. The requested documents contained in the node are provided to the client 101, so as to be browsed by the user.

The document classification method according to the present invention is described above.

Furthermore, the program codes provided in the present invention is not the only one possible. Those skilled in the art can implement the present invention with various program codes under the teaching of the above ideas, as long as the object of the present invention can be implemented.

As mentioned above, for the personalized classification design according to the present invention, all we need to do is to select (for example, dragging and dropping operation by a mouse) on the client, with respect to the flat category structure provided by the server, and apply the above method Anode (for example, clicking the mouse) to the category database of the existing system. Since there is no model (classifier) for any personalized structure in the present invention, it does not need to train the plurality of the classification models, and all personalized document classifications can be generated on the basis of a unified classification model. Thus, the method according to the present invention is very efficient and practical for the personalized classification.

The embodiment of the present invention described above is only one example. It should not be used to define the scope of the present invention. Those skilled in the art will understand that various equivalent changes and transformations can be made on the basis of the embodiment of the present invention, and all of which should belong to the scope covered by the present invention.

Variations described for the present invention can be realized in any combination desirable for each particular application. Thus particular limitations, and/or embodiment enhancements described herein, which may have particular advantages to the particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A document classification method, including the steps of:
for a server and a client connected via a network, creating a plurality of categories on a server side, assigning documents to be browsed by a user according to corresponding categories, and managing said plurality of categories in a flat structure; and
on a client side, selecting required categories from the plurality of categories to create a personalized classification structure for the user.

2. The document classification method according to claim 1, characterized in that said personalized classification structure is a tree structure, and each node of said tree structure includes one or more categories.

3. The document classification method according to claim 2, characterized by further comprising the step of, on the client side, browsing the required documents by selecting a specific node in the tree structure.

4. The document classification method according to claim 3, characterized in that step of creating further comprises the steps of:
creating a category set which contains said plurality of categories, and each of said categories has the first identification information;
creating a document set which contains all documents to be browsed, and each of said documents has the second identification information;
creating a bit string array containing a plurality of bit string, wherein each bit string represents the position of its corresponding category in said category set; and
creating a corresponding category table for each of said categories, in which the second identification information of the respective documents belonging to the category is stored.

5. The document classification method according to claim 4, characterized by further comprising the step of:
binary-classifying each document, wherein if a document belongs to a certain category, the result of binary-classifying the document under the category is 1, and the second identification information of the document is inserted into said category table of the category; if a document does not belong to a certain category, the result of binary-classifying the document under the category is 0.

6. The document classification method according to claim 5, characterized by further comprising the step of creating a category update list and a document update list to record the update status of said categories and said documents respectively.

7. The document classification method according to claim 6, characterized in that: the first identification information of said categories includes the first positional information of the categories in said category set, and the second identification information of said documents includes the second positional information of the documents in said document set.

8. The document classification method according to claim 7, characterized by further comprising the step of, when a category is deleted, deleting corresponding bit string, and marking said first positional information in said category update list, which represents that the position is empty.

9. The document classification method according to claim 8, characterized by further comprising the step of:
when a category is inserted, searching said category update list at first, and if a marked first positional information is found, then inserting the category into the corresponding position in said category set, and deleting said first positional information in said category update list;
if no marked first positional information is found, then inserting the category into a new position in said category set; and
adding the bit string corresponding to the inserted category into the bit string array.

10. The document classification method according to claim 7, characterized by further comprising the step of when a document is deleted, deleting the second identification information of said document from said category table, and marking said second positional information in said document update list, which represents that the position is empty.

11. The document classification method according to claim 10, characterized by further comprising the step of:
when a document is inserted, searching said document update list at first, and if a marked second positional information is found, then inserting the document into the corresponding position in said document set, and deleting said positional information in said document update list;
if no marked second positional information is found, then inserting the document into a new position in said document set; and
inserting said second identification information into said category table.

12. The document classification method according to claim 2, characterized in that step of selecting further comprises the steps of:
when a root node is created, performing a logical “OR” operation or a logical “AND” operation on the selected one or more categories, the result serving as the categories contained in the root node; and
when a sub-node is created, performing a logical “OR” operation or a logical “AND” operation on the one or more categories selected for the sub-node, and performing a logical “AND” operation on the result and the categories in the parent node of the sub-node, the result of the latter logical “AND” operation serving as the categories contained in the sub-node.

13. The document classification method according to claim 3, characterized in that step of browsing further comprises the steps of:
determining the respective categories contained in a specific node by selecting the specific node;
determining the number of documents recorded in the category table corresponding to the respective categories; and
starting to search for the documents to be browsed from the category containing the fewest documents.

14. The document classification method according to claim 13, characterized in that further comprising the step of providing a list of the resultant documents to said client side in real time.

15. The document classification method according to claim 14, characterized by further comprising the steps of:
selecting the documents to be browsed from the list of said documents on the client side; and
providing the selected documents to said client side, so as to be browsed by the user.

16. A document classification system, including a server and a client connected through a network, characterized by further comprising:
system classifying means configured on said server side for creating a plurality of categories for the respective documents to be browsed by the user, assigning said respective documents to the corresponding categories, and managing said plurality of categories in a flat structure; and
customizing means configured on said client side for selecting the required categories from said plurality of categories to create a personalized classification structure.

17. The document classification system according to claim 16, characterized in that said system classification means further comprises an initializing unit for performing initializing operation on the various basic information models.

18. The document classification system according to claim 17, characterized in that said system classification means further comprises updating means for performing updating process on said documents and said categories.

19. The document classification system according to claim 18, characterized in that said personalized classification structure is a tree structure, and each node of said tree structure comprises at least one categories.

20. The document classification system according to claim 16, further comprising browsing means configured on said client side for receiving the required documents provided by the server side and presenting them to the user in the case that a specific node of the tree structure is selected.

21. An article of manufacture comprising a computer usable medium having computer readable program code means embodied therein for causing document classification, the computer readable program code means in said article of manufacture comprising computer readable program code means for causing a computer to effect the steps of claim 1.

22. A computer program product comprising a computer usable medium having computer readable program code means embodied therein for causing document classification, the computer readable program code means in said computer program product comprising computer readable program code means for causing a computer to effect the functions of claim 16.
